(19) United States
(12) Patent Application Publication
(10) Pub. No.: US 2006/0232068 A1
(43) Pub. Date: Oct. 19, 2006

(54) Self powered electrical system

(76) Inventor: Harold Shirlee, Little Rock, AR (US)

Correspondence Address: Harold Shirlee, 5406 Dreher Lane, Little Rock, AR, 72209, US

(21) Appl. No.: 11/037,947

(22) Filed: Apr. 7, 2005

(51) Int. Cl. H02K 7/18; F03G 7/08; F02B 63/04

(52) U.S. Cl. 290/1 R

(57) ABSTRACT

The SELF POWERED ELECTRICAL SYSTEM is an invention that will produce enough electric power to operate itself indefinitely along with any other electrical operated machine, tool, or equipment without the need of any outside power source or fuel. Thus, eliminating the need for fuel.

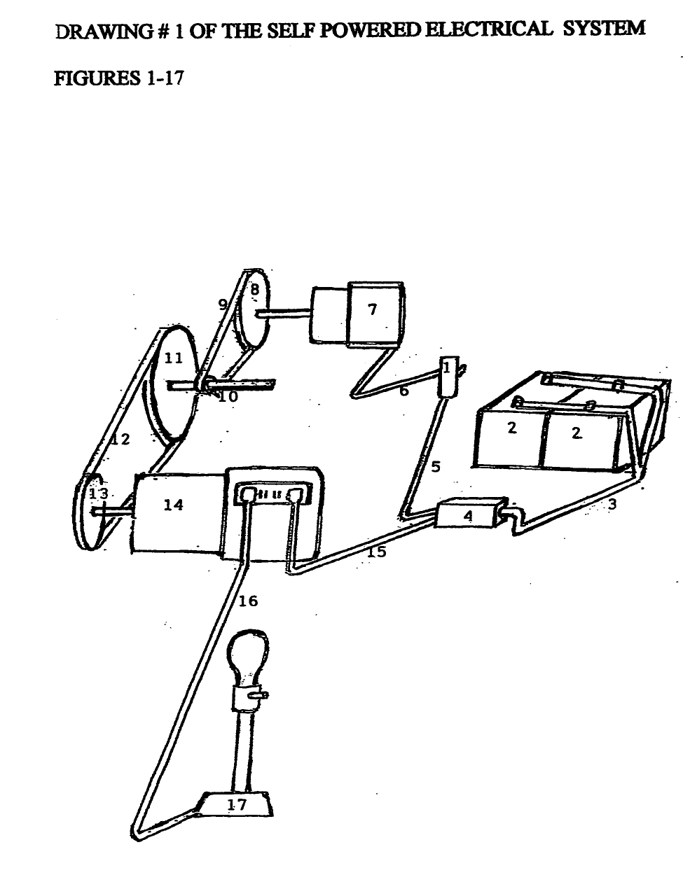

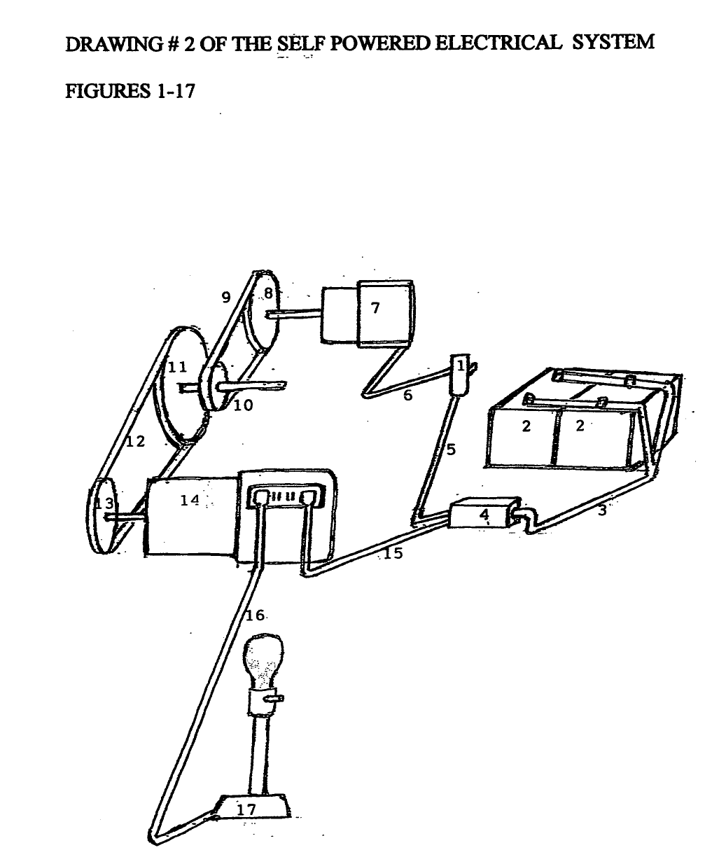

This invention make claim to the provisional patent filed Oct. 22, 2004. The confirmation no. 4621

### BACKGROUND OF THE INVENTION

The invention relates to a self powered electrical system. It is an electrical system that operates from its own power. It does not require any outside source of energy or fuel to operate itself. At the same time it will produce enough electrical power to operate another electrical tool, appliance, or machine.

There are electrical generator already available. However, all of these generators require an outside fuel source in order to operate. This does not solve the fuel problem of the world.

Thus, there is a need for a self powered electric invention that will produce its own required electrical power for operation, plus produce enough electrical power to operate another electrical tool, appliance, or machine. This is what this self powered electrical system does.

### SUMMARY OF THE INVENTION

The object of this invention is to provide a self powered electrical system that can run continually without any other outside source of fuel.

Another object of this invention is to offer a solution to the world's fuel problem.

It is a further object of this invention to make it possible for a household to operate completely on the self powered electrical system without having to paid an electric or gas bills. Once the self powered electrical system is installed the only cost will be that of maintenance to the system.

To accomplish these related objects this invention is engineered in a way that will cause a generator to run continually upon its own electrical power source, and produce enough electrical power to operate other tools, appliances, or machines. This is illustrated in the drawing and the prototype picture of the gear box.

However, the drawings and the prototype pictures of the gear box are illustrative only variations are contemplated as being part of the invention. Limited only by the scope of the claims.

### DETAIL DESCRIPTION OF THE OPERATION OF THE SELF POWERED ELECTRICAL SYSTEM FROM DRAWING #1

First the off and on switch (1) is moved to the on position. This causes electrical power from the batteries (2) to travel through the battery cable (3) through the voltage regulator (4) to the off and on switch (1). The off and on switch (1) sends electrical power through electrical motor cord (6) to the electrical motor (7). This will cause the electrical motor (7) to turn the electrical motor 3¼ in. pulley wheel (8) that will turn the drive belt (9) that will turn the small ½ in. gear pulley wheel (10) that will turn the large 6 in. gear pulley wheel (11) (FIVE times the RPM of the electric motor 3¼ in. pulley wheel (8)). The large 6 in. gear pulley wheel (11) will turn the gear wheel drive belt (12) that will turn the generator 3¼ in. pulley wheel (13) TEN times the RPM of the electric motor 3¼ pulley wheel (8) that will turn the generator (14).

Electrical power from the generator (14) goes through the voltage regulator cord (15) to the voltage regulator (4) that will power the electric motor (7) through the electrical motor cord (6). Also the voltage regulator (4) will recharges the batteries (2) through battery cable (3). When batteries (2) are charged the voltage regulator (4) will stop the charge and continue to power the electric motor (7) through the electric motor cord (6). Also in start up the voltage regulator (4) will supply the electric motor (7) with electric power from the batteries (2) until the generator (14) reaches its full RPM.

By causing the generator 3¼ in. pulley wheel (13) to have TEN times the RPM of the electric moter 3¼ in. pulley wheel (8) is what cause the generator (14) to supply enough electrical power to power itself through the electric motor (7) and the test light (17): that represent any electrical tool or appliance.

### Detail Description of the Operation of the Self Powered Electrical System from Drawing #2

First the off and on switch (1) is moved to the on position. this causes electrical power from the batteries (2) to travel through the battery cable (3) through the voltage regulator (4) to the off and on switch (1). The off and on switch (1) sends electriacl power through electrical motor cord (6) to the electrical motor (7). This will cause the electrical motor (7) to turn the electrical motor 3¼ in. pulley wheel (8) that will turn the puny wheel drive belt (9) that will turn the 1¼ in. gear pulley wheel (10) that will turn the large 6 in. gear pulley wheel (11) (two and ONE HALF times the RPM of the electrical moter 3¼ in. pulley wheel (8)). The large 6 in. gear pulley wheel (11) will turn gear wheel drive belt (12) that will turn the generator 3¼ in. pulley wheel (13) (FIVE times the RPM of the electric moter 3¼ in. pulley wheel (8)) that will turn the generator (14)

Electrical power from the generator (14) goes through the voltage regulator cord (15) to the voltage regulator (4) that will power the electric motor (7) through the electrical motor cord (6). Also the voltage regulator (4) will recharges the batteries (2) through battery cable (3). When batteries (2) are charged the voltage regulator (4) will stop the charge and continue to power the electric motor (7) through the electric motor cord (6). Also in start up the voltage regulator (4) will supply the electric motor (7) with electric power from the batteries (2) until the generator (14) reaches its full RPM.

By causing the generator 3¼ pulley wheel (13) to have FIVE times the RPM of the electric motor 3¼ in. pulley wheel (8) is what causes the generator (14) to supply enough electric power to power itself through the electric motor (7) and the test light (17): that represent any electric tool or appliance.

1. It is a perpetual recycling energy device.
